(19) United States
(12) Patent Application Publication
(10) Pub. No.: US 2026/0221780 A1
(43) Pub. Date: Jul. 30, 2026

(54) HYBRID ENERGY STORAGE AND DELIVERY SYSTEMS

(71) Applicant: Energy Vault, Inc., Westlake Village, CA (US)

(72) Inventors: Craig Richard Horne, Danville, CA (US); Peter Andrew Wittenberg, Denver, CO (US); Brendan Patrick Shaffer, San Clemente, CA (US)

(21) Appl. No.: 19/456,780

(22) Filed: Jan. 22, 2026

Related U.S. Application Data
(60) Provisional application No. 63/749,231, filed on Jan. 24, 2025.

(51) Int. Cl. H02J 3/38; H02J 9/08; H02J 15/50; H02J 101/10; H02J 101/22; H02J 101/28; H02J 101/30; H02J 101/40

(52) U.S. Cl. CPC H02J 3/381; H02J 15/50; H02J 9/08; H02J 2101/10; H02J 2101/22; H02J 2101/28; H02J 2101/30; H02J 2101/40

(57) ABSTRACT

A hybrid energy storage and delivery system can include a stationary hybrid energy storage and delivery system and a mobile hybrid energy storage and delivery system. The mobile energy storage and delivery system may include a hydrogen carrier unit and a mobile fuel cell unit. The mobile fuel cell unit can include a heat transfer system, a fuel cell, and a power exchanger. The system may include a mobile battery unit. The mobile battery unit can include a battery, a power exchanger, and a control. The system may include a medium voltage switch gear, including a first medium voltage transformer and a second medium voltage transformer. The first medium voltage unit and the second medium voltage unit can be connected to the medium voltage switchgear, and the medium voltage switchgear can supply electricity to a grid system.

### CROSS REFERENCE

This application claims priority to U.S. Provisional Application No. 63/749,231, filed Jan. 24, 2025, the disclosure of which is incorporated herein by reference in its entirety for all purposes. Any and all applications for which a foreign or domestic priority claim is identified in the Application Data Sheet as filed with the present application are hereby incorporated herein by reference in their entirety under 37 CFR 1.57 for all purposes.

### BACKGROUND

### Field

The present disclosure is directed to an energy storage and delivery system, and more particularly to an energy storage and delivery system and a method for storing energy and delivering electricity via or including a hybrid mobile energy storage system.

### Certain Related Art

Systems that generate power from green energy sources continue to grow. However, many of these systems are unpredictable, inconvenient, and/or may require a large area of real estate.

### SUMMARY

Accordingly, there is a need for an improved system to capture electricity generated from green energy sources (also referred to as clean energy, renewable energy, or sustainable energy) for predictable delivery to the electrical grid and/or to support a resiliency system in the event of a power outage.

One concern relates to environmental impact of power generation systems that do not use green energy sources. Sources of green energy can come from renewable resources and be produced in a way that poses less harm to the environment compared to fossil fuel sources. For example, diesel generators create pollutants and greenhouse gas emissions (GHGEs) which can, among other things, exacerbate respiratory conditions and contribute to global warming. The hybrid energy storage system of the present disclosure advantageously uses a combination of battery, hydrogen-fed generators, and forms of hydrogen carriers (e.g., gaseous hydrogen, liquid hydrogen, ammonia, Liquid Organic Hydrogen Carriers (LOHCs), etc.) to produce clean and reliable energy. In one implementation, even the liquid hydrogen itself can come from renewable sources. For example, the liquid hydrogen that is used in the system of the present disclosure can come from an electrolysis plant powered by renewable energies such as solar and/or wind energy.

Another concern relates to the amount of space available to accommodate an energy storage and delivery facility. Stationary facilities can require a large footprint of land to accommodate the various components of the facility that need to be fixed to the ground. As energy storage facilities are typically located in dense and/or urban areas, acquiring additional real estate may not be an option. Furthermore, some of the battery storage facilities are only used during a short period of the year. Therefore, dedicating a large area of land to a facility that may be operated for only a few months of the year may not be economically feasible. The system of the present disclosure advantageously provides an efficient method for the users (e.g., owners, operators, etc.) of an energy storage and delivery system to operate such facilities without the need to acquire additional real estate and/or dedicate a large area of land to these facilities throughout the year, advantageously decreasing capital expenditures for such systems. For example, the system of the present disclosure can include one or more hydrogen trailers that are physically located at the energy storage facility with the capability to integrate additional hydrogen trailers (located outside the energy storage facility) to the system as needed (e.g., based on power demand from the grid).

As discussed above, one concern relates to the amount of space available to accommodate an energy storage and delivery facility. The system of the present disclosure can further address this concern by providing hydrogen tank(s) that are capable of dynamic tank pressure operation. To reduce the footprint of liquid hydrogen (LH2) tank(s), the system of the present disclosure can operate the LH2 tank(s) at a low pressure when not discharging such that the density of LH2 in the tank is as high as possible. Upon needing to discharge, the LH2 tank can be pressurized to provide the proper inlet pressure required by the fuel cell system that receives the liquid hydrogen. The LH2 tank can take days to reach thermal equilibrium with the resultant decrease in LH2 density. Therefore, at the start of the discharge event, there will be more energy storage capacity in the system. Advantageously, this allows for a smaller LH2 tank (requiring a smaller footprint) than if the LH2 tank was always at the higher pressure required for the operation of the fuel cell system and can reduce the overall cost of the system. This feature also provides additional benefits for refueling operations and can apply to both a stationary, and/or a mobile hybrid energy storage and delivery system.

Another concern relates to the noise level associated with energy storage and delivery facilities. As discussed above, energy storage and delivery facilities are typically located in dense and/or urban areas. As a result, energy storage facilities that generate excessive noise (e.g., gas turbines, diesel generators, etc.) can be disruptive to the neighborhood. Advantageously, the energy storage and delivery system of the present disclosure can operate with reduced noise level which can enable such systems to be implemented in dense and/or urban areas without disrupting the neighborhood.

Another concern relates to the response time of an energy storage and delivery system. An energy storage and delivery system that cannot respond immediately to a blackout event can result in a period of downtime in a part of the grid system. Advantageously, the energy storage and delivery system of the present disclosure can provide black start capabilities that allow the grid system to recover from a blackout event. The system of the present disclosure can be a resiliency system which responds rapidly to major power disruptions, thereby eliminating any downtime in the grid system. The system of the present disclosure can support additional supply volumes (e.g., by including additional liquid hydrogen in the tanks or bringing additional tanks) and/or allow for refueling (of the tanks) to provide electricity for an extended period. The energy system of the present disclosure can utilize the quick response time provided by batteries combined with long lasting and clean electricity provided by different forms of hydrogen carriers (e.g., gas, liquid, LOHCs, NH3, etc.) to provide an efficient and clean energy system that can withstand and recover quickly from power outages. The system of the present disclosure can support customers with diurnal-varying loads (e.g., data centers) and/or steady-load applications.

Another concern relates to the availability of liquid hydrogen and liquid hydrogen trailers. For example, a resiliency system may be called to use for only a few months of the year. Therefore, it may not be economical or practical to have a large amount of liquid hydrogen stored at the site. The system of the present disclosure enables users to utilize mobile hydrogen trailers which can be dispatched from one site to another and/or from a central hub to different facilities. For example, the user can have a fleet of mobile hydrogen trailers that supply hydrogen to different facilities to provide a needed amount of resiliency to each facility without having a large amount of liquid hydrogen stored in one location. In some implementations, the system of the present disclosure can include Artificial Intelligence (AI) and/or Machine Learning (ML) features that predict the amount of resiliency required in a given site (e.g., based on forecasted weather conditions, such as a prolonged heat event), which can be used to intelligently dispatch liquid hydrogen trailers to different facilities based on the predicted need. Advantageously, the system of the present disclosure is not limited to liquid hydrogen and can accommodate other forms of hydrogen (H2). For example, the system of the present disclosure can use other H2 carriers such as hydrogen gas, ammonia (NH3), Liquid-Organic Hydrogen Carriers (LOHCs) such as methylcylohexane, acetone, dibenzyltoluene, and Electrochemically-Rechargeable Liquids (ERLs) such as diluted alcohols such as propanol or butanediol, the glycolic-/oxalic-acid couple, or aqueous ionic solutions such as Cr(II)/Cr(III) chlorides or V(II)/V(III) sulfates in the same conceptual manner as LH2.

Another concern relates to the boil off associated with liquid hydrogen tanks. Although liquid hydrogen is typically stored in storage tanks that are vacuum insulated to minimize heat transfer, heat transfer still occurs and can cause at least some evaporation of the stored liquid hydrogen. This evaporation results in lowering the liquid hydrogen level in the tanks, thus requiring the user to supply liquid hydrogen continuously to these tanks to compensate for the amount that is evaporated. Advantageously, the system of the present disclosure can enable users to supply liquid hydrogen tanks to different sites which can minimize the amount of unused liquid hydrogen that needs to be stored for a prolonged period at a given site. Furthermore, the system of the present disclosure can use the boil off from the stored liquid hydrogen to generate electricity.

Another concern relates to augmentations and/or upgrades that may need to be implemented in an energy storage and delivery system. In an energy storage and delivery system that is fixed to the ground, it may not be easy to implement any future augmentation and/or upgrade (e.g., increase in energy storage/generation capacity) without requiring new construction. The energy storage and delivery system of the present disclosure enables users to operate an energy storage and delivery system that includes mobile components, thus allowing for easy replacement and/or augmentation (e.g., increase in energy storage/generation capacity) to accommodate future needs. For example, if the electricity demand in an area increases, additional mobile hydrogen storage tanks can be brought to the facility, permanently or temporarily, to provide support for the additional demand.

In some aspects, the system of the present disclosure is a refillable primary battery. In one example, the system of the present disclosure is a primary hydrogen-oxygen battery system that is mechanically rechargeable.

In some implementations, the hybrid energy storage and delivery system can be a hybrid energy resiliency delivery system, a hybrid stationary and mobile energy resiliency delivery system, a hybrid energy resiliency system, a hybrid stationary and mobile energy resiliency system, or a hybrid energy resiliency delivery system.

In some embodiments, the techniques described herein relate to an energy storage and delivery system, as shown and described herein.

In some embodiments, the techniques described herein relate to a method of storing energy and generating electricity, as shown and described herein.

In some embodiments, the techniques described herein relate to an energy storage and delivery system. The energy storage and delivery system can include: a mobile hydrogen carrier unit; a mobile fuel cell unit, the mobile fuel cell unit including, for example: a heat transfer module; a fuel cell module; and a power exchange module; a mobile battery unit, the mobile battery unit including, for example: a battery module; a power transfer module; and a control module; a medium voltage switch gear container; a first medium voltage transformer; and a second medium voltage transformer. In some aspects, the first medium voltage transformer is connected to the mobile fuel cell unit, and the second medium voltage transformer is connected to the mobile battery unit. In some aspects, the first medium voltage transformer and the second medium voltage transformer are connected to a medium voltage switchgear, and the medium voltage switchgear is configured to deliver electricity to a grid system.

In some embodiments, the techniques described herein relate to an energy storage and delivery system, wherein the mobile hydrogen carrier unit can include one of gaseous hydrogen or liquid hydrogen or ammonia or Liquid Organic Hydrogen Carriers (LOHCs).

In some embodiments, the techniques described herein relate to an energy storage and delivery system, wherein the mobile hydrogen carrier unit can include liquid hydrogen.

In some embodiments, the techniques described herein relate to an energy storage and delivery system, wherein the first medium voltage transformer and the second medium voltage transformer can be mobile.

In some embodiments, the techniques described herein relate to an energy storage and delivery system that can include two or more mobile hydrogen carrier units.

In some embodiments, the techniques described herein relate to an energy storage and delivery system, wherein the heat transfer module can include a vaporizer and be configured to convert liquid hydrogen to hydrogen gas.

In some embodiments, the techniques described herein relate to an energy storage and delivery system, wherein the mobile fuel cell unit can have an output electricity of about 480VAC.

In some embodiments, the techniques described herein relate to an energy storage and delivery system, wherein the power exchange module of the mobile fuel cell unit can include an inverter and internal controls.

In some embodiments, the techniques described herein relate to an energy storage and delivery system, wherein the mobile fuel cell unit can be configured to receive liquid hydrogen from the mobile hydrogen carrier unit.

In some embodiments, the techniques described herein relate to an energy storage and delivery system, wherein the switchgear can be a mobile switchgear station including: configurable protection relays for proper coordination with utility protection devices; synchronizing relays enabling seamless transformer to and from grid connection.

In some embodiments, the techniques described herein relate to an energy storage and delivery system, wherein the transformer can be configured: in a delta or wye configuration on medium voltage side of transformer; delta configuration on a low voltage side of the transformer; and with voltage tap changer for several different low voltage configurations (<1000Vac line-to-line) and medium voltage configurations (<69kVac line-to-line).

In some embodiments, the techniques described herein relate to an energy storage and delivery system, including a mobile medium voltage power station, wherein: the switchgear can be a mobile switchgear station including: configurable protection relays for proper coordination with utility protection devices; synchronizing relays enabling seamless transformer to and from grid connection; the transformer can be configured: in a delta or wye configuration on medium voltage side of transformer; delta configuration on a low voltage side of the transformer; and with voltage tap changer for several different low voltage configurations (<1000Vac line-to-line) and medium voltage configurations (<69kVac line-to-line).

In some embodiments, the techniques described herein relate to an energy storage and delivery system, including a mobile auxiliary system including: a central control system with HVAC to coordinate dispatch of mobile fuel cell unit(s) and mobile battery unit(s); a back-up diesel generator for emergency power to control systems and black-start enabled inverters; and an auxiliary transformer for control systems critical loads.

In some embodiments, the techniques described herein relate to an energy storage and delivery system, where the control modules in the mobile fuel cell unit and mobile battery unit can be self-contained with historian and control capabilities and capable of standardized communication with a central control system, the central control system having HVAC to coordinate dispatch of mobile fuel cell unit(s) and mobile battery unit(s).

In some embodiments, the techniques described herein relate to an energy storage and delivery system, wherein the hydrogen unit can be configured to operate with dynamic pressure such that the system operates at a low pressure when the system is not discharging hydrogen.

In some embodiments, the techniques described herein relate to a method for storing energy and providing electricity using hydrogen, the method can include: providing a mobile battery unit; providing a mobile fuel cell unit; providing a mobile hydrogen carrier unit; providing a medium voltage switch gear unit; providing a first medium voltage transformer and a second medium voltage transformer, the first medium voltage transformer operatively connected to the mobile fuel cell unit, and the second medium voltage transformer operatively connected to the mobile battery unit, wherein the first medium voltage transformer and the second medium voltage transformer can be operatively connected to a medium voltage switchgear; and connecting the medium voltage switchgear to a grid system.

In some embodiments, the techniques described herein relate to a method, wherein the mobile hydrogen carrier unit can include one of gaseous hydrogen, or liquid hydrogen, or ammonia, or Liquid Organic Hydrogen Carriers (LOHCs).

In some embodiments, the techniques described herein relate to a method, wherein providing the mobile hydrogen carrier unit can include a step of dispatching a liquid hydrogen trailer from an electrolysis plant.

In some embodiments, the techniques described herein relate to a method, wherein the electrolysis plant can be powered by renewable energy sources.

In some embodiments, the techniques described herein relate to a method, wherein the renewable energy sources can be solar energy and wind energy.

In some embodiments, the techniques described herein relate to a method that can further include coordinating delivery of electricity with a utility company and/or directly to an electricity grid.

In some embodiments, the techniques described herein relate to a method, wherein coordinating delivery of electricity can include a step of: receiving a first notification from the utility company regarding a need for an electricity for an affected area; receiving a second notification that the affected area is de-energized and isolated from a transmission line, the second notification being received prior to providing the electricity to the affected area; and receiving a third notification from the utility company to ramp down the electricity to the affected area.

In some embodiments, the techniques described herein relate to an energy storage and delivery system that can include: a mobile hydrogen carrier unit; a mobile generator; a mobile battery unit, the mobile battery unit including: a battery module; a power transfer module; and a control module; a medium voltage switch gear container; a first medium voltage transformer; and a second medium voltage transformer, wherein the first medium voltage transformer is connected to a generator, and the second medium voltage transformer is connected to the mobile battery unit. In some aspects, the first medium voltage transformer and the second medium voltage transformer can be connected to a medium voltage switchgear, and the medium voltage switchgear can be configured to deliver electricity to a grid system.

In some embodiments, the techniques described herein relate to an energy storage and delivery system, wherein the mobile generator can be a fuel cell unit.

In some embodiments, the techniques described herein relate to an energy storage and delivery system, wherein the mobile generator can be a linear generator or a combustion turbine.

In some embodiments, the techniques described herein relate to an energy storage and delivery system, wherein the combustion turbine can be a hydrogen combustion turbine.

In some embodiments, the techniques described herein relate to an energy storage and delivery system, wherein the mobile hydrogen carrier unit can include one of gaseous hydrogen or liquid hydrogen or ammonia or Liquid Organic Hydrogen Carriers (LOHCs).

### BRIEF DESCRIPTION OF THE DRAWINGS

FIG. 1 illustrates a diagram of some components of a hybrid energy storage and delivery system.

FIG. 2 is a schematic perspective view of a hybrid stationary energy storage and delivery system.

FIG. 3 is a schematic perspective view of a hybrid mobile energy storage and delivery system according to one aspect of the present disclosure.

FIG. 4A is a schematic view of a hybrid mobile energy storage and delivery system according to one aspect of the present disclosure.

FIG. 4B is a schematic view of a hybrid mobile energy storage and delivery system according to one aspect of the present disclosure.

FIG. 5 is a schematic view of a mobile fuel cell unit according to one aspect of the present disclosure.

FIG. 6 is a schematic view of a mobile battery unit according to one aspect of the present disclosure.

FIG. 7 is a schematic view of a hybrid mobile energy storage and delivery system, including a regional hub, according to one aspect of the present disclosure.

### DETAILED DESCRIPTION

Disclosed below is a hybrid energy storage and delivery system. In one implementation, the hybrid energy storage and delivery system can be or include a mobile hybrid energy storage system and can include methods for storing energy and delivering electricity. The electricity that is generated in the mobile hybrid energy storage system can be operatively connected to an electrical grid to provide electricity to residential, commercial, and/or industrial consumers in a Public Safety Power Shutoff (PSPS) event (also referred to as a blackout event or power outage event throughout this application).

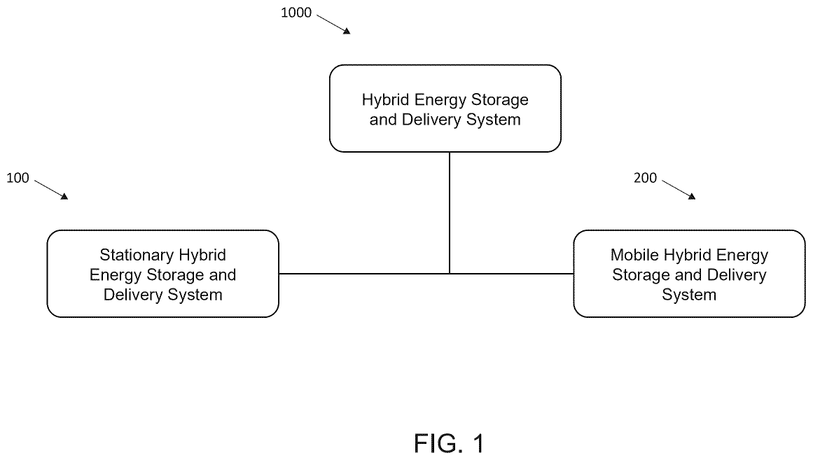

FIG. 1 illustrates a diagram of some components of a hybrid energy storage and delivery system 1000. The hybrid energy storage and delivery system 1000 can be an energy storage and delivery system that uses more than one source of energy to generate electricity. For example, the hybrid energy storage and delivery system 1000 can include a mobile hybrid energy storage and delivery system 200, which can use a combination of (lithium-ion) batteries and fuel cells to generate electricity. The hybrid energy storage and delivery system 1000 can optionally also include a stationary hybrid energy storage and delivery system 100 (also referred to as a stationary energy system 100) in addition to a mobile hybrid energy storage and delivery system 200 (also referred to as a mobile energy system 200). The stationary energy system 100 can include components that are affixed (e.g., permanently) to the ground. The mobile energy system 200 can include components that are mobile (e.g., movable and/or not permanently affixed to the ground).

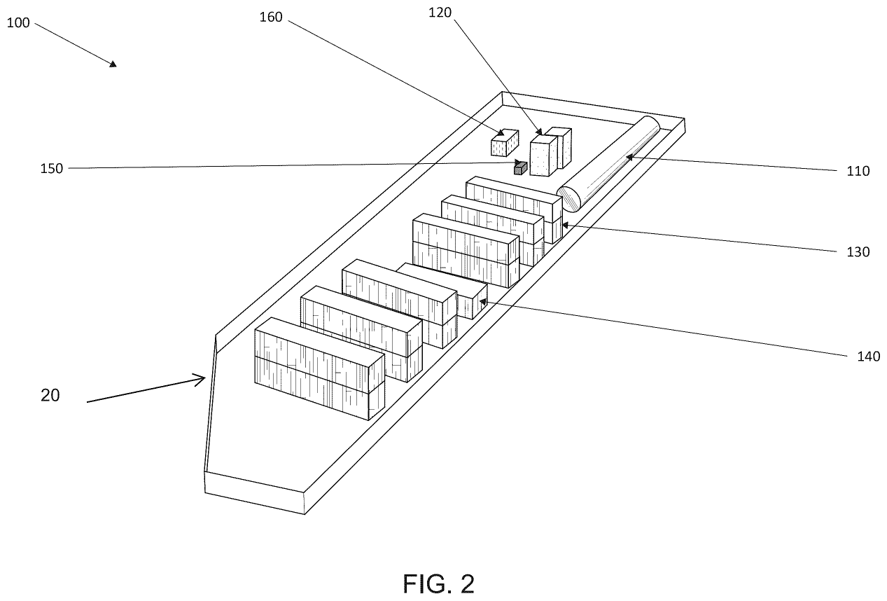

FIG. 2 is a schematic perspective view of a stationary hybrid energy storage and delivery system 100 (e.g., stationary energy system) located within a perimeter 20, which can include several components. The components of the stationary energy system 100 can work together to provide an energy storage and delivery system that can store energy and selectively deliver electricity to an electric grid (e.g., a city's electric grid). In some implementations, the stationary energy system 100 can include a control house unit 150 and a Medium Voltage Switchgear (MVSG) 160. The control house unit 150 can include a plurality of components. In one example, the control house unit 150 includes a central Energy Management System (EMS) with heating, ventilation and air conditioning (HVAC), a back-up diesel generator, an auxiliary transformer, and one or more power distribution panels. In one example, the control house unit 150 can be affixed to the ground. The EMS can coordinate dispatch of fuel cells. The auxiliary transformer, backed up by the diesel generator, may provide back-up power to critical control. The MVSG 160 can connect the project to grid or customer load and include necessary relays for proper coordination with utility protection systems. In some implementations, the stationary energy system 100 can include a hydrogen tank 110, a vaporizer 120, a fuel cell unit 130, a battery unit 140, a control house unit 150, and a medium voltage switchgear unit 160.

The hydrogen tank 110 can be capable of storing liquid hydrogen and can be affixed to the ground. The vaporizer 120 can provide heat to vaporize the liquid hydrogen and can be affixed to the ground. The fuel cell unit 130 can use the vaporized liquid hydrogen to generate electricity. The fuel cell unit 130 can be affixed to the ground. The battery unit 140 can include a plurality of lithium-ion battery cells. The battery unit 140 can also be affixed to the ground similar to the hydrogen tank 110, the vaporizer 120, and the fuel cell unit 130. The number of units of hydrogen tank, vaporizer, fuel cell, and/or battery can be increased as needed to scale the power capacity and/or the energy storage capacity of the system.

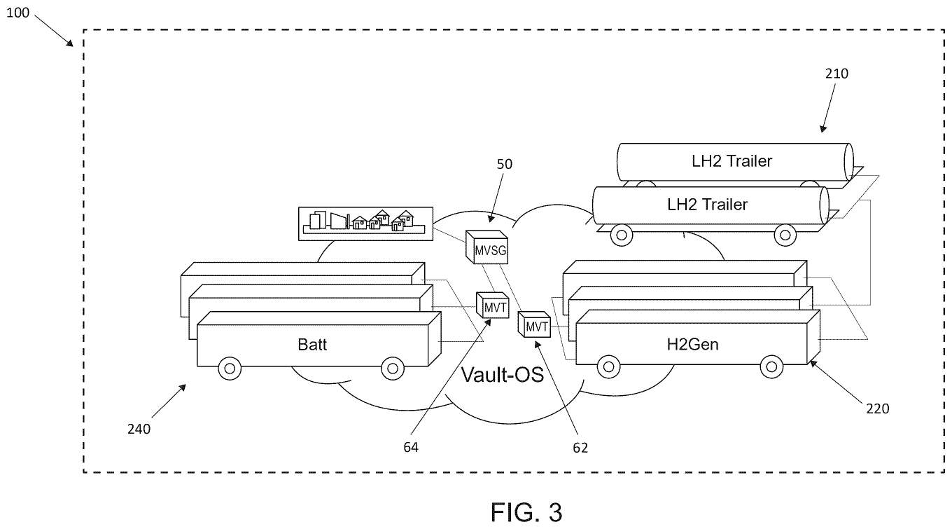

FIG. 3 illustrates some components of the mobile energy system 200 according to one implementation of the present disclosure. The mobile energy system 200 can include a plurality of components. In one example, the mobile energy system 200 can include a mobile hydrogen unit 210, a mobile fuel cell unit 220, a mobile battery unit 240. In one example, the mobile hydrogen unit 210 can provide 47 MWh (MV-AC) of equivalent electrical energy storage capacity. In some implementations, the mobile fuel cell unit 220 is a generator. In some implementations, the generator can be other suitable types of generators (e.g., a linear generator or a hydrogen combustion turbine). In one example, the mobile fuel cell unit 220 can provide 1 MW (MV-AC) of electrical power capacity. In one example, the mobile battery unit 240 can provide 1 MW/2 MWh (AC) of electrical power and electrical energy storage capacity. Furthermore, the mobile energy system 200 can include other electrical components, such as a first medium voltage transformer 62, a second medium voltage transformer 64, and a medium voltage switchgear 50. Advantageously, the mobile hydrogen unit 210, the mobile fuel cell unit 220 and the mobile battery unit 240 are separately mounted on different trailers, allowing them to be separately transported to a site, as needed, as further discussed below.

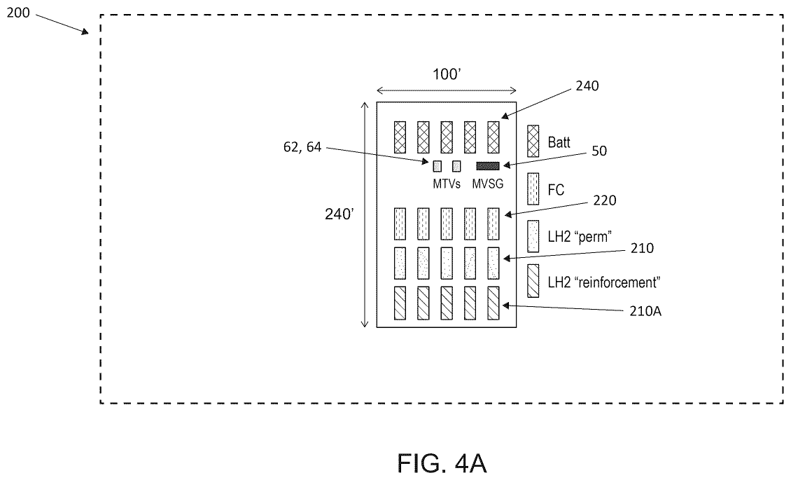

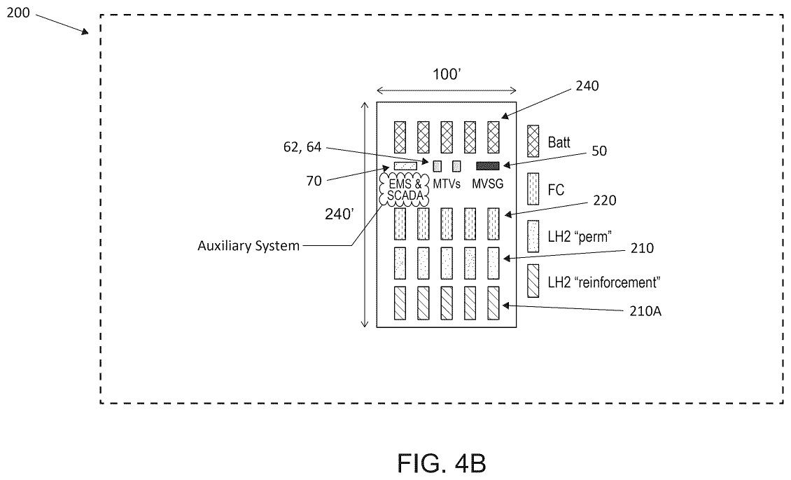

FIG. 4A is a schematic view of the arrangement of some components of the mobile energy system 200 according to one implementation. As discussed above and illustrated in FIG. 4A, the mobile energy system 200 can include the mobile hydrogen unit 210, the mobile hydrogen unit 210 (such as a reinforcement mobile hydrogen container 210A), the mobile fuel cell unit 220, and the mobile battery unit 240 (collectively referred to as a train). The mobile energy system 200 can include one or a plurality of trains as needed to generate the desired amount of electricity. Additional trains can be implemented in the mobile energy system 200 in parallel with the existing trains to scale the power capacity and/or the energy storage capacity of the system. In some implementations, one train can provide about 500 kilowatt (kW) or about 1 Megawatt (MW) or about 2 MW of electricity. In some implementations, one train can provide an amount of electricity that includes any value between about 500 kW to about 2 MW of electricity. The ratio of the number of the mobile hydrogen units 210 to the number of mobile fuel cell units 220 (number of the mobile hydrogen units: number of mobile fuel cell units) can be 1:1, 1:2, 1:4, or other appropriate values based on the user's need.

As discussed above, the mobile energy system 200 can include the mobile hydrogen unit 210. In some implementations, each train includes only one mobile hydrogen unit 210. The mobile hydrogen unit 210 can include other components, such as Vacuum Jacketed Piping (VJP) and Vacuum Insulated Piping (VIP). The mobile hydrogen unit 210 can include any commercially available container mounted on a set of wheels (e.g., a trailer) that is capable of transporting liquid hydrogen on roads. It is appreciated that liquid hydrogen needs to be stored at an extremely low temperature (e.g., about −423° F.). Accordingly, the mobile hydrogen unit 210 can be capable of transporting liquid hydrogen at a very low temperature. For example, the mobile hydrogen unit 210 can include an advanced insulation system to reduce (e.g., minimize) the transfer of heat to the liquid hydrogen. In one example, the mobile hydrogen unit 210 can hold about 4 tons of liquid hydrogen (and insulate the liquid hydrogen in the container from the environment). The mobile hydrogen unit 210 can be coupled to a powered vehicle (e.g., a tractor unit) to travel from one location to another.

With continued reference to FIG. 4A, the mobile energy system 200 can include other electrical components, such as one or more Medium Voltage Transformers (MVT) (e.g., the first medium voltage transformer 62 and/or the second medium voltage transformer 64), and/or a Medium Voltage Switchgear (MVSG) (the medium voltage switchgear 50). The MVSG is a switchgear station and can include configurable protection relays for proper coordination with utility protection devices and synchronizing relays enabling seamless transfer with utility protection devices. The medium energy storage switchgear may be mobile or affixed to the ground. An MVT can be any commercially available transformer that meets the project specification and can alter the voltage level coming from the mobile fuel cell unit 220 and/or mobile battery unit 240 depending on the user's need. For example, the first medium voltage transformer 62 can take the 480 VAC output generated in mobile fuel cell unit 220 and bring it up to about 12,000 volts. The MVT can alter the voltage generated by the mobile fuel cell unit 220 and/or mobile battery unit 240 to the level that is used by residential and/or industrial customers as well as utility distribution voltage networks or customers. In some implementations, the first medium voltage transformer 62 and the second medium voltage transformer 64 can be mobile. Advantageously, the user can move one or more MVTs from one site or another or use MVTs from local rental stores without the need to custom-build an MVT for a particular site. Similarly, the MVSG can be any commercially available switchgear that has the required specification based on the project requirements. The MVSG can also be mobile which can provide it with the same or similar advantages as discussed earlier with respect to MVTs.

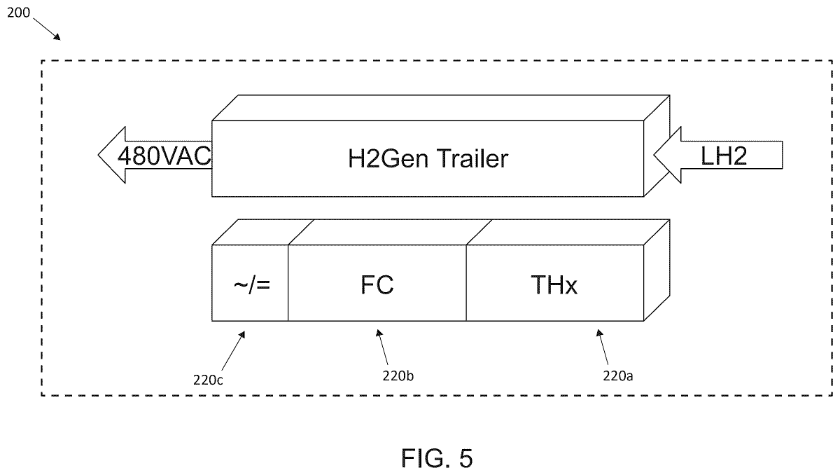

Referring to FIG. 5, as discussed above, the mobile energy system 200 can include one or a plurality of mobile fuel cell units 220, which can be mounted on a set of wheels (e.g., a trailer) that is capable of travel on roads. The mobile fuel cell unit 220 can include a heat transfer system 220a (also referred to as a heat transfer module 220a), a fuel cell 220b (also referred to as the fuel cell module 220b), and a power electronics (PEx) module 220c (also referred to as a power exchange, a power exchanger, or PEx module). The heat transfer module 220a, fuel cell module 220b, and PEx module 220c can be connected to (e.g., mechanically and/or operatively) to one another. In one example, an end (e.g., distal end) of the heat transfer module 220a is coupled to an end (e.g., proximal end) of the fuel cell module 220b, and an end (e.g., distal end) of the fuel cell module 220b is coupled to an end (e.g., a proximal end) of the PEx module 220c. In one example, the fuel cell module 220b can have a peak power generation of 1 MW and base power generation of 0.8 MW.

With continued reference to FIG. 5, the heat transfer module 220a (or heat transfer system) can include several components such as a liquid hydrogen vaporizer and/or a fuel cell cooler which can be integrated in the heat transfer module 220a. In some implementations, the liquid hydrogen vaporizer can vaporize about 72 kg of liquid hydrogen in one hour. In one example, the liquid hydrogen vaporizer can operate at a pressure above atmospheric pressure (e.g., a pressure of 6 bar). In one example, the heat transfer module 220a can include one or more resistive heaters. In one example, the heat transfer module 220a can include one or more fans. In one example, the heat transfer module 220a can have a base heat rejection of 1 MWt and a peak heat rejection of 1.2 MWt. The mobile fuel cell unit 220 can also include a battery unit. The vaporizer in the heat transfer module 220a can receive the required power from a battery that is included in the mobile fuel cell unit 220 or from the mobile battery unit 240. Advantageously, the heat transfer module 220a of the mobile fuel cell unit 220 draws heat from the fuel cells to cool them and utilizes such heat to vaporize liquid hydrogen the mobile fuel cell unit 220 receives from the mobile hydrogen unit 210, thereby providing more efficient operation of the mobile energy system 200 at least because it avoids the use of separate vaporizer units to vaporize liquid hydrogen and separate heat exchanger units to cool the fuel cells. In one example, the PEx module 220c can operate at 1.25 MVA with 800 to 1000VDC input and 480 VAC or 690 VAC output. In some implementations, the PEx module can be air-cooled, drawing from ambient or an air-liquid heat exchanger in the heat transfer module that is providing hot air to vaporize liquid hydrogen. In some implementations, the PEx module can be liquid-cooled (e.g., by integration of a liquid heat exchanger with the heat transfer module).

Still referring to FIG. 5, in some implementations, the fuel cell module 220b can be hydrogen rated and can include a plurality of engines (e.g., 6, 7, 8, etc.). The PEx module 220c can include several components. For example, the PEx module 220c can include an inverter unit, a thermal management module, and an internal control. The inverter unit can convert Direct Current (DC) to Alternating Current (AC) or vice versa. The heat transfer module 220a, fuel cell module 220b, and PEx module 220c can be arranged back-to-back (such as the arrangement illustrated in FIG. 5) and can be included inside a container (e.g., a metal enclosure). In operation, the vaporizer in the heat transfer module 220a can vaporize the liquid hydrogen that is being delivered to the mobile fuel cell unit 220 from the mobile hydrogen unit 210, which can then be converted to electricity in the fuel cell module 220b. The ability of the system of the present disclosure to accommodate the heat transfer module 220a in the same container as the fuel cell module 220b can have several advantages. For example, it can reduces (e.g., minimizes) the heat loss as the vaporized liquid hydrogen travels through the system. The inverter in the PEx module 220c can convert the DC generated in the fuel cell module 220b to AC. In one example, the mobile fuel cell unit 220 can have an output of 480 Volts Alternating Current (VAC).

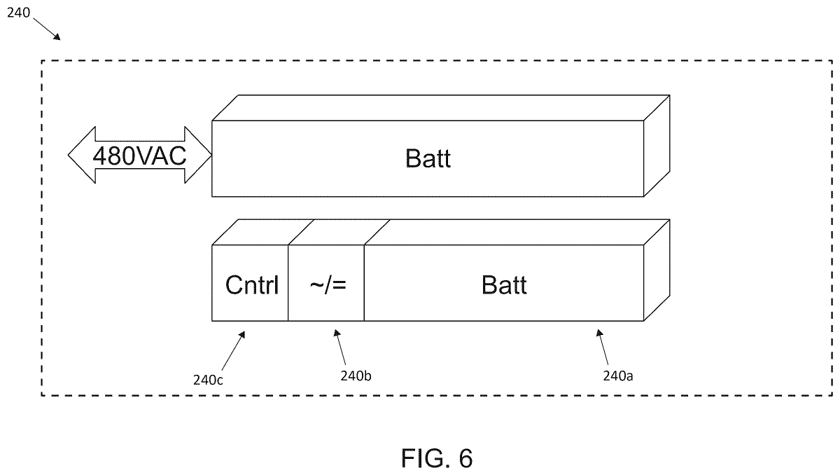

FIG. 6 illustrates the mobile battery unit 240 according to one implementation of the present disclosure, which can be mounted on a set of wheels (e.g., a trailer) that is capable of travel on roads. In one example, the mobile battery unit 240 can include a battery 240a (also referred to as a battery module 240a), a power exchanger 240b or power transfer (also referred to as PEx module 240b or power transfer module 240b), and a control 240c (also referred to as a control module 240c). The battery module 240a, PEx module 240b, and control module 240c can be connected (e.g., mechanically, and/or operatively) to one another in the mobile battery unit 240. In one example, an end (e.g., distal end) of the battery module 240a is coupled to an end (e.g., proximal end) of the PEx module 240b, and an end (e.g., distal end) of the PEx module 240b is coupled to an end (e.g., a proximal end) of the control module 240c. In one example, the mobile battery unit can provide 2.2 MWh (DC) or 1 MW(AC) for two hours. In some implementations, the PEx module 240b includes characteristics and configurations that are different than the PEx module 220c of the mobile fuel cell unit 220.

The battery module 240a can include different components. For example, the battery module 240a can be a lithium-ion battery. The battery module 240a can include one or more battery cells. The battery module 240a can absorb the initial shock to the system in a blackout event. The battery module 240a can have a quick response time and can provide the initial electricity (e.g., to the electric grid) until the electricity from the mobile fuel cell units 220 ramps up to meet the demand. The PEx module 240b can include different components (such as an inverter unit, internal controls, a Power Conversion System (PCS), etc.). The control module 240c can include different components and can be manufactured such that it can snap in place (during the manufacturing process or at the site) in the mobile battery unit 240. In some implementations, the mobile battery unit 240 can include an Energy Management System (EMS). The EMS can alternate/adjust the output electricity between the mobile fuel cell unit 220 and the mobile battery unit 240.

Each mobile fuel cell unit 220 can include dedicated control modules that are self-contained with historian and control capabilities with the capability of assigning a master control module within a mobile fuel cell to coordinate the dispatch of other mobile fuel cell unit control modules. Alternatively, as depicted in FIG. 4B, the mobile energy system 200 can have a separate auxiliary system that can include a plurality of components. In one example, the mobile energy system 200 includes the central EMS with HVAC, a back-up diesel generator, an auxiliary transformer, and power distribution panels. The auxiliary system may be mobile or stationary (e.g., affixed to the ground). The EMS will coordinate dispatch of fuel cells, either by communicating to dedicated control modules in each mobile fuel cell unit or sub-system communications interface devices. The auxiliary transformer, backed up by the diesel generator, may provide back-up power to critical control loads in the Auxiliary System and the mobile energy system 200.

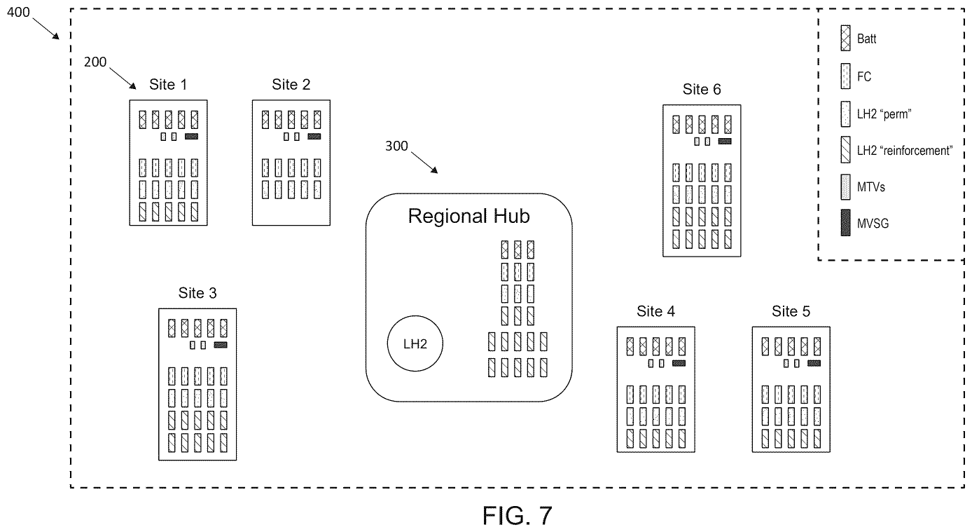

FIG. 7 illustrates a regional mobile energy system, which can be a regional energy system 400. The regional energy system 400 can include a plurality of mobile energy systems 200 that can be supported from a regional hub 300. The regional hub 300 can include different components that are included in a train. In one example, the regional hub 300 can include a fleet of liquid hydrogen trailers (e.g., mobile hydrogen units 210) that can be supplied to different facilities that utilize the mobile energy system 200 based on the user's need and/or the required demand in each facility. Advantageously, this arrangement can reduce the total number of liquid hydrogen trailers (e.g., mobile hydrogen units 210) needed to support the regional energy system 400. The site(s) supported by the regional hub 300 can also include a stationary hybrid energy storage and delivery system 100 that has a hydrogen tank 110 with a fitting to connect a mobile hydrogen unit 210 to allow expansion of the energy storage capacity, and can additionally include portable MVSG and MVT that provide connections for trains to allow expansion of the power capacity.

### Example Sequence of Operation

As discussed above, the mobile energy system 200 can provide an improved system to capture electricity generated from renewable resources to deliver predictable and reliable electricity to the electrical grid in the event of a power outage. In one example, the following describes some of the non-limiting steps (in any appropriate order) that can be taken to provide the energy storage and delivery system according to one implementation of the present disclosure. First, the user acquires the land, or rights to its use, where the mobile energy system is to be located. In one example, a system that has a capability of generating and/or delivering about 10 MWh of electricity per hour and sustain that level for over 36 hours can be located in an area of about 0.5 acres, which can be significantly smaller than a similar system that does not use the techniques and methods described herein. Once the user chooses the land where the energy storage and delivery system is to be located and all the administrative and permitting processes are completed, the user can proceed to prepare the land (e.g., demolish any obstruction, provide a level surface, etc.) in preparation for receiving the equipment that is utilized in the system of the present disclosure.

The user can then deliver the equipment to the site. In some implementations, some (or all) of the equipment used in the system of the present disclosure can be mobile. The equipment used in the system of the present disclosure can include (but is not limited to) a battery unit (e.g., the mobile battery unit 240), a fuel cell unit (e.g., the mobile fuel cell unit 220), a hydrogen unit (e.g., the mobile hydrogen unit 210), one or more medium voltage transformers (e.g., the first medium voltage transformer 62 and/or the second medium voltage transformer 64), and a switchgear (e.g., the medium voltage switchgear 50) with an optional external control skid 70. The various equipment used in the system of the present disclosure can be connected to one another according to the specification of the project.

Once the equipment of the system of the present disclosure is connected to one another such that the system is operational, the user needs to coordinate the operation of the system with the owner of the utility company that the system is intended to support. In one example, coordinating with the owner of the utility company can include the following steps: first, the utility company determines that the support of the system of the present disclosure is needed and provides an appropriate notice (e.g., a 48-hour notice) to the operations team of the system. The utility company can then de-energize the affected area that is scheduled to be supported by the system and isolate the affected area from the utility company's transmission line. Once the affected area is de-energized and ready to receive the system's support, the EMS can black start the affected area using the electricity from the mobile battery unit(s). As discussed above, the mobile battery units can have a quick response time which can be used for the initial ramp up. As time passes by, the EMS can adjust the system so that the electricity from the mobile battery unit(s) ramp down while bringing up the electricity from the fuel cell unit(s). Since the system of the present disclosure is a mobile system, additional liquid hydrogen trailers (i.e., reinforcement trailers) can be brought to the site as needed to support the system. For example, the ability to bring additional liquid hydrogen trailers can expand the storage capacity of the system, thus providing electricity for an extended period.

Once the utility company determines that the electricity from the system is no longer needed, the utility company can instruct the operations team of the system to ramp down the electricity output to zero. The utility company can then proceed to re-connect the affected area to the transmission line such that the affected area is back to being supported (e.g., completely) by the electricity from the utility company.

While certain embodiments of the invention have been described, these embodiments have been presented by way of example only and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. For example, although certain embodiments of the present disclosure refer to the use of liquid hydrogen, the system(s) and/or method(s) of the present disclosure are not limited to hydrogen in a liquid state, and other forms of hydrogen (e.g., gaseous hydrogen, liquid hydrogen, ammonia, Liquid Organic Hydrogen Carriers (LOHCs), etc.) can be equally used in various embodiments of the present disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result.

The scope of the present disclosure is not intended to be limited by the specific disclosures of preferred embodiments in this section or elsewhere in this specification and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. An energy storage and delivery system, comprising:
a mobile hydrogen carrier unit;
a mobile fuel cell unit, the mobile fuel cell unit comprising:
a heat transfer system;
a fuel cell; and
a power exchanger;
a mobile battery unit, the mobile battery unit comprising:
a battery;
a power transfer system; and
a control;
a medium voltage switchgear;
a first medium voltage transformer; and
a second medium voltage transformer, wherein the first medium voltage transformer is connected to the mobile fuel cell unit, and the second medium voltage transformer is connected to the mobile battery unit;
wherein the first medium voltage transformer and the second medium voltage transformer are connected to the medium voltage switchgear, and the medium voltage switchgear is configured to deliver electricity to a grid system.

2. The energy storage and delivery system of claim 1, wherein the mobile hydrogen carrier unit comprises one of gaseous hydrogen or liquid hydrogen or ammonia or Liquid Organic Hydrogen Carriers (LOHCs).

3. The energy storage and delivery system of claim 1, wherein the mobile hydrogen carrier unit comprises liquid hydrogen.

4. The energy storage and delivery system of claim 1, wherein the first medium voltage transformer and the second medium voltage transformer are mobile.

5. The energy storage and delivery system of claim 1, comprising two or more mobile hydrogen carrier units.

6. The energy storage and delivery system of claim 1, wherein the heat transfer system comprises a vaporizer and is configured to convert liquid hydrogen to hydrogen gas.

7. The energy storage and delivery system of claim 1, wherein the mobile fuel cell unit has an output electricity of about 480VAC.

8. The energy storage and delivery system of claim 1, wherein the power exchanger of the mobile fuel cell unit comprises an inverter and internal controls.

9. The energy storage and delivery system of claim 1, wherein the mobile fuel cell unit is configured to receive liquid hydrogen from the mobile hydrogen carrier unit.

10. The energy storage and delivery system of claim 1, wherein the switchgear is a mobile switchgear station comprising:
configurable protection relays for proper coordination with utility protection devices; and
synchronizing relays enabling seamless transformer to and from grid connection.

11. The energy storage and delivery system of claim 1, wherein the first medium voltage transformer or the second medium voltage transformer can be configured:
in a delta or wye configuration on medium voltage side of transformer;
delta configuration on a low voltage side of the transformer; and
with voltage tap changer for different low voltage configurations and medium voltage configurations.

12. The energy storage and delivery system of claim 1, comprising a mobile auxiliary system comprising:
a central control system with HVAC to coordinate dispatch of a mobile fuel cell unit and a mobile battery unit;
a back-up diesel generator for emergency power to control systems and black-start enabled inverters; and
an auxiliary transformer for control systems critical loads.

13. The energy storage and delivery system of claim 1, wherein the mobile hydrogen carrier unit is configured to operate with dynamic pressure such that the energy storage and delivery system operates at a low pressure when the system is not discharging hydrogen.

14. A method for storing energy and providing electricity using hydrogen, the method comprising:
providing a mobile battery;
providing a mobile fuel cell;
providing a mobile hydrogen carrier;
providing a medium voltage switchgear;
providing a first medium voltage transformer and a second medium voltage transformer, the first medium voltage transformer operatively connected to the mobile fuel cell, and the second medium voltage transformer operatively connected to the mobile battery, wherein the first medium voltage transformer and the second medium voltage transformer are operatively connected to a medium voltage switchgear; and
connecting the medium voltage switchgear to a grid system.

15. The method of claim 14, wherein the mobile hydrogen carrier comprises one of gaseous hydrogen, or liquid hydrogen, or ammonia, or Liquid Organic Hydrogen Carriers (LOHCs).

16. The method of claim 14, wherein providing the mobile hydrogen carrier comprises a step of dispatching a liquid hydrogen trailer from an electrolysis plant.

17. The method of claim 16, wherein the electrolysis plant is powered by one or more renewable energy sources.

18. The method of claim 17, wherein the one or more renewable energy sources comprise solar energy and wind energy.

19. The method of claim 14, further comprising coordinating delivery of electricity with a utility company and/or directly to an electricity grid.

20. The method of claim 19, wherein coordinating delivery of electricity comprises a step of:
receiving a first notification from the utility company regarding a need for an electricity for an affected area;
receiving a second notification that the affected area is de-energized and isolated from a transmission line, the second notification being received prior to providing the electricity to the affected area; and
receiving a third notification from the utility company to ramp down the electricity to the affected area.
